(19) United States
(12) Patent Application Publication
(10) Pub. No.: US 2013/0020126 A1
(43) Pub. Date: Jan. 24, 2013

(54) POWER SUPPLY FOR A COMPUTER SYSTEM HAVING CUSTOMIZEABLE CABLE EXTENSIONS

(71) Applicant: Charles Robert McMenomey, III, Campbell, CA (US)

(72) Inventor: Charles Robert McMenomey, III, Campbell, CA (US)

(73) Assignee: OCZ TECHNOLOGY GROUP INC., San Jose, CA (US)

(21) Appl. No.: 13/551,914

(22) Filed: Jul. 18, 2012

Related U.S. Application Data
(60) Provisional application No. 61/505,187, filed on Jul. 19, 2011.

(51) Int. Cl. H01R 4/00; H01R 43/00

(52) U.S. Cl. 174/72 R; 29/825

(57) ABSTRACT

Power supply systems and methods for their use in computer systems. The systems and methods make use of a power supply unit to which a main power cable and multiple cable stubs are electrically connected. The power cable is adapted to provide power to a motherboard of a computer system, and the multiple cable stubs are adapted to provide power to peripheral devices within the computer system. At least two of the cable stubs have different lengths. Each of the cable stubs has a device-specific female connector configured to mate with a specific class of the peripheral devices. The power supply system further includes at least one extension cable adapted to connect to the device-specific female connector of at least one of the cable stubs to allow extension of the cable stub or to power more than one of the peripheral devices.

### CROSS REFERENCE TO RELATED APPLICATIONS

This application claims the benefit of U.S. Provisional Application No. 61/505,187, filed Jul. 19, 2011, the contents of which are incorporated herein by reference.

### BACKGROUND OF THE INVENTION

The present invention generally relates to power supply systems for use with computer systems. More particularly, this invention relates to a power supply system with customizable cable extensions that can be added on demand to existing cable stubs in order to supply power to peripheral devices, including but not limited to mass storage media.

The Advanced Technology Extended (ATX) standard has defined specifications according to which most modern computer systems are built. Nonetheless, it is this standardization that allows for highly customizable configurations. For example, most current personal computers feature, as mass storage media, a single hard disk drive (HDD) or solid state drive (SSD) along with an optical drive. However, especially the recent trend to use personal computers for audio visual content creation such as video editing has created a demand for multiple hard disk drives and/or solid state drives to provide additional storage for original and edited footage. Additionally, a spare drive is often used for backup of critical data. Moreover, even mid-range systems most often feature at least two optical drives to facilitate a direct copy of optical media without the need to save the contents to the hard disk drive first. Especially in the case of enthusiast-level or workstation grade computers, the typical configuration includes more than one hard disk drive, potentially several solid state drives and, moreover, at least one optical drive which can be of the DVD, dual layer DVD or Blue Ray drive (BD) type.

Each drive needs to receive power from the power supply system of a computer. All internal peripheral devices of a computer system are typically powered through a single ATX power supply unit. The supply power for HDDs is typically 12V and the power supply for optical drives is either 12V or 5V, whereas in the case of SSDs the power supply is typically only 5V. In addition, some 2.5-inch HDDs and SSDs use a 3.3V supply, though drives using 3.3V are primarily used in the mobile or notebook sector since they can tap directly into a 3.3V power rail, thus avoiding loss of power efficiency caused by a step-down converter from 5V. Most 2.5-inch drives in the desktop and workstation market sector only use 5V power supplies.

As known in the art, ATX power supply systems have a plurality of cables to supply power to system devices with various types of connectors. The most common examples are cables supplying auxiliary power to PCIe devices and cables supplying power to HDDs and SSDs. Of the latter, older units typically feature at least two identical cables, each having at least two 4-pin Molex connectors and a floppy disk power connector. Up to four such identical cables can be present. In more recent generations of power supply systems, at least some of the 4-pin Molex connector cables have been replaced with cables having 15-pin SATA power connectors as an adaptation to the change in storage media technology from parallel ATA to Serial ATA. Accordingly, many modern power supply systems have two to four cables with up to four Serial ATA power connectors. The physical configuration of the cables is generally identical, that is, number and spacing of the power connectors is the same for all cables.

Since all cables of the same class, that is PCIe or drive power, are typically duplicates of each other, the connectors will reach the same physical locations for the target devices. In the worst case, this could mean that there is a redundancy for some connectors, meaning, that some devices are within the physical reach of several of the available connectors, whereas some other devices are going to be hard to reach. This is particularly true since there are physical dependencies between the different connectors on one cable caused by the spacing between them. Consequently, even if one connector could reach a particular drive, the drive may still be out of reach for that particular connector since another connector of the same cable is already connected to a different device. Consequently, one of the connectors on a second cable must be used, which brings all other connectors on that second cable into the enclosure, even if they are functionally not needed.

The above situation is further complicated in enclosures with multiple drive bays, for example, hard disk drives or solid state drives mounted along with optical drives at the front of the enclosure, which is the most advantageous placement for the latter. Additional HDDs/SSDs are often mounted next to the system's power supply unit at the top of the enclosure. In order to supply power to even a single back-up drive at the top position of the case, usually a full cable with two to four connectors needs to be dedicated.

Accordingly, power supply systems not only need to have enough power to drive all devices but they also need to have enough cables to deliver power to the devices. In most commercially available solutions, this has been addressed by either adding multiple cables with multiple connectors each to the DC-current output side of the power supply unit, as represented in FIG. 1, or by using a modular design having jacks into which supply cables can be inserted on an as-needed basis, as represented in FIG. 2. For convenience, the same reference numbers are used to identify components that are shown in both FIGS. 1 and 2 and have an identical or similar function. FIG. 1 represents a power supply system 10 including a power supply unit 12 that contains internal components of the power supply system 10. The power supply unit 12 is hard-connected to a main (motherboard) power cable 14 equipped with a power connector 16 and hard-connected to three supply cables 18 that are equipped with a device connector 20. FIG. 2 represents a power supply system 10 including a power supply unit 12 equipped with jacks 22. A main power cable 14 equipped with a power connector 16 and three supply cables 18 equipped with device connectors 20 are represented as being adapted to be individually inserted into the jacks 22 to electrically connect the cables 14 and 18 to the power supplied by the power supply unit 12.

Power supply systems of the type shown in FIG. 2 have the disadvantage that it is often difficult to install additional cables into a DC access panel of the power supply unit once the power supply unit is installed into a computer chassis. Both solutions described above have the disadvantage of being limited in their capability to be customized, and therefore have the potential to have insufficient or too many device connectors for most computer system configurations. Only in the rarest case will the available cables match the number and physical locations of the devices to be powered. Optical, hard disk or solid state drives will often be relatively close to the power supply unit but only long cable extensions are available and, consequently, the cables must be looped around within the enclosure resulting in unnecessary clutter. This makes servicing of the computer difficult, including cleaning of the interior, and furthermore obstructs airflow, thereby causing thermal problems for devices.

In view of the above, it is clear that improved power supply units are needed to allow for more efficient and customizable cable systems within a computer system.

### BRIEF DESCRIPTION OF THE INVENTION

The present invention provides methods and power supply systems suitable for supplying power to peripheral devices in a computer system, for example, mass storage media, with an efficient and customizable cable system.

According to a first aspect of the invention, a power supply system for a computer system includes a power supply unit to which a main power cable and multiple cable stubs are electrically connected. The main power cable is adapted to provide power to a motherboard of the computer system and the multiple cable stubs are adapted to provide power to peripheral devices within the computer system. At least first and second cable stubs of the cable stubs have different length. Each of the cable stubs has a device-specific female connector configured to mate with a specific class of the peripheral devices. The power supply unit further includes at least one extension cable adapted to connect to the device-specific female connector of one of the cable stubs to allow extension of the cable stub or to power more than one of the peripheral devices.

According to a second aspect of the invention, a method of powering a computer system includes installing a power supply system in a computer system. The power supply system has a power supply unit to which a main power cable and multiple cable stubs are electrically connected. The main power cable is adapted to power a motherboard of the computer system and the multiple cable stubs are adapted to provide power to peripheral devices within the computer system. At least first and second cable stubs of the cable stubs have different length. Each cable stub has a device-specific female connector configured to mate with a specific class of the peripheral devices. At least one extension cable is connected to the device-specific female connector of one at least one of the cable stubs. The extension cable is adapted to extend the cable stub or to power more than one peripheral device. The cable stubs and/or the extension cable are connected to the peripheral devices.

A technical effect of the invention is the ability to fully customize a cable system for a power supply system of a computer system adapted to power multiple peripheral devices that may be located in various locations within the system relative to the power supply unit.

Other aspects and advantages of this invention will be better appreciated from the following detailed description.

### BRIEF DESCRIPTION OF THE DRAWINGS

FIG. 1 schematically represents a typical ATX-style power supply unit with an ATX motherboard power cable and a plurality of supply cables, each having several connectors.

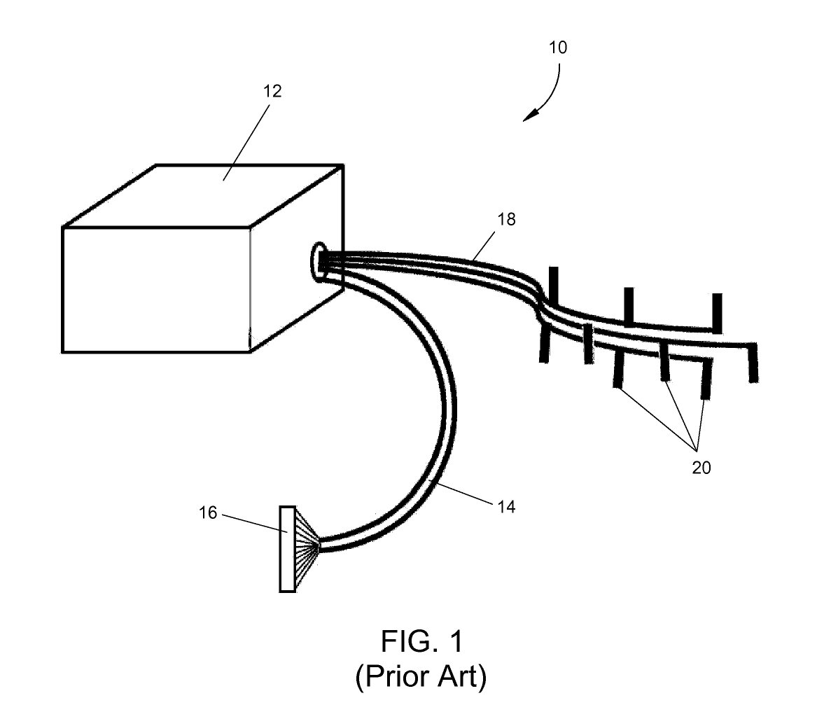

FIG. 2 schematically represents a modular power supply unit with a similar assortment of cables as that of the power supply unit shown in FIG. 1.

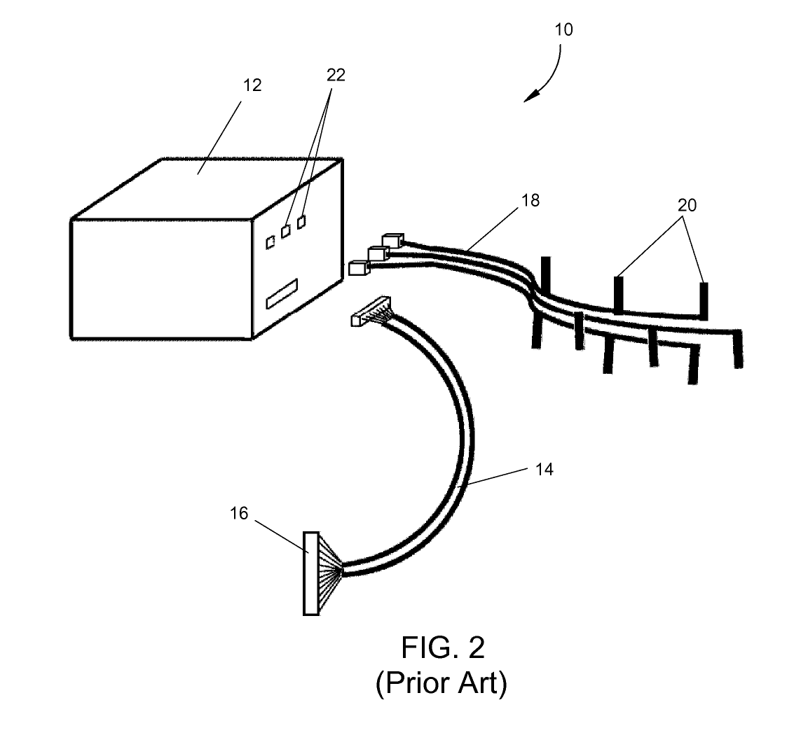

FIG. 3 schematically represents a power supply unit with two primary cable stubs of substantially different lengths, each equipped with a connector into which an extension cable can be inserted in accordance with a preferred aspect of the invention.

FIG. 4 schematically represents a portion of an extension cable and shows the extension cable as having a T-connector equipped with a male connector adapted to receive power and a female connector adapted to supply power to a peripheral device in accordance with a preferred aspect of the invention.

FIG. 5 schematically represents an extension cable suited to be plugged into a female connector on a cable stub by the male connector of the T-connector and configured to supply power to peripheral devices through the female connector of the T-connector and two additional female power connectors on the extension cable in accordance with an aspect of the invention.

FIG. 6 schematically represents a cable stub of the type represented in FIG. 3 and two single-ended extension cables suited to be daisy-chained in a configuration capable of supplying power to three peripheral devices in accordance with an aspect of the invention.

### DETAILED DESCRIPTION OF THE INVENTION

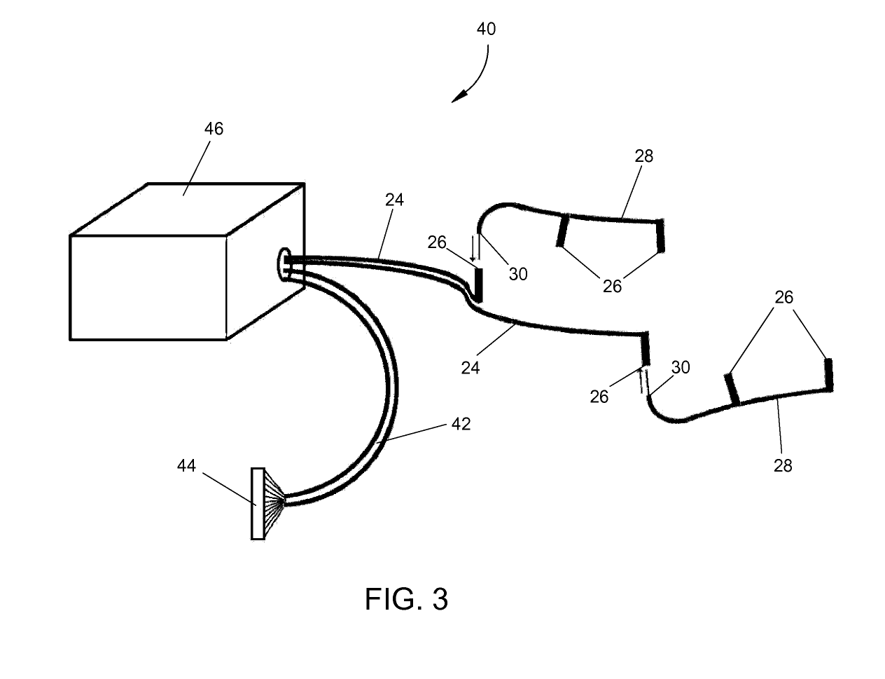

The present invention provides a power supply system for a computer system having a flexible cable configuration using stubs and extensions. FIG. 3 schematically represents a power supply system 40 for use in a computer system in accordance with a particular aspect of the invention. The power supply system 40 has multiple cable stubs 24 and a main power cable 42 with a power connector 44, for example, a single 20-pin ATX or 24-pin ATX power connector, adapted to be plugged into a motherboard (not shown) of the computer system. Both the cable stubs 24 and main power cable 42 are represented in FIG. 3 as being hard-connected to a power supply unit 46 of the power supply system 40. The power supply unit 46 contains internal components of the power supply system 40 which may be of any type suitable for use in power supply units for computer systems. The cable stubs 24 may be of various lengths, and in preferred embodiments of the invention have substantially different lengths, for example, differ by 50% or more, in order to accommodate peripheral devices throughout the interior of the computer system. The number of cable stubs 24 can vary according to the overall power rating of the power supply unit 46 as well as based on marketing decisions, though at least two cable stubs 24 are present.

Each cable stub 24 has at least one device-specific, for example SATA, female connector 26 configured to allow for directly powering a specific class of peripheral devices. Customizable extension cables 28 are provided and adapted to be connected to the female connector 26 of each cable stub 24 to supply DC power to a plurality of peripheral devices, including, but not limited to, mass storage devices such as solid state drives and/or hard disk drives. The female connectors 26 are preferably configured as touch-proof connectors, that is, no active electrical contacts can be accidentally touched by a user.

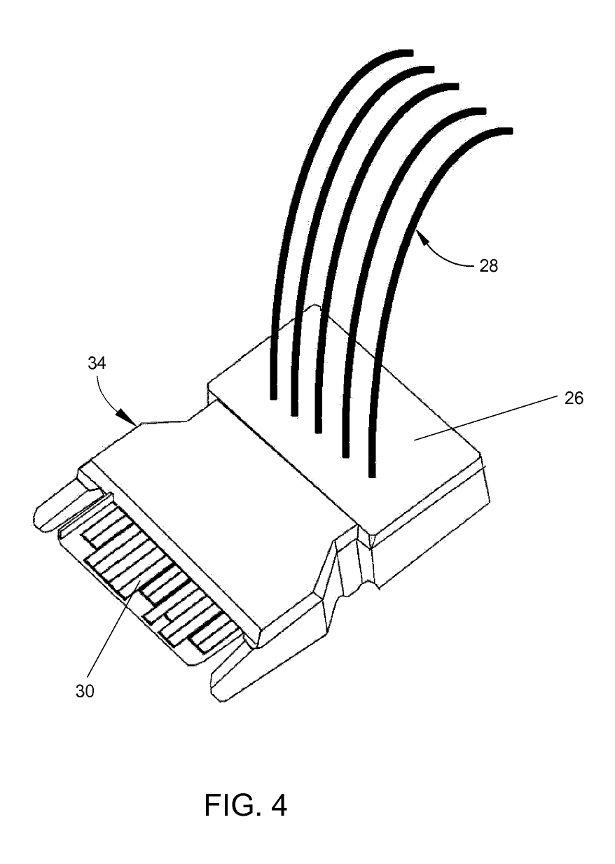

In accordance with one aspect of the invention, the power supply unit 46 and its cable stubs 24 are used in combination with at least one extension cable 28 having a male connector 30 that may be connected to the female connector 26 of the cable stub 24 and, extending from there, a plurality of additional female connectors 26 located at incremental distances from the male connector 30 on the extension cable 28. FIG. 4 represents an exemplary male connector 30 of one of the extension cables 28. In this example, the male connector 30 is represented as part of a T-connector 34 having the male connector 30 to receive power and a female connector adapted to supply power to a peripheral device of the computer system. As the female connector of the T-connector 34 can be identical to the aforementioned female connectors 26 of the extension cable 28, it is also identified by reference number 26 in the figures. While the female connector 26 of the T-connector 34 supplies power to the peripheral device, the male connector 30 may be inserted into the female connector 26 of one of the cable stubs 24, thereby receiving power from the power supply unit 46.

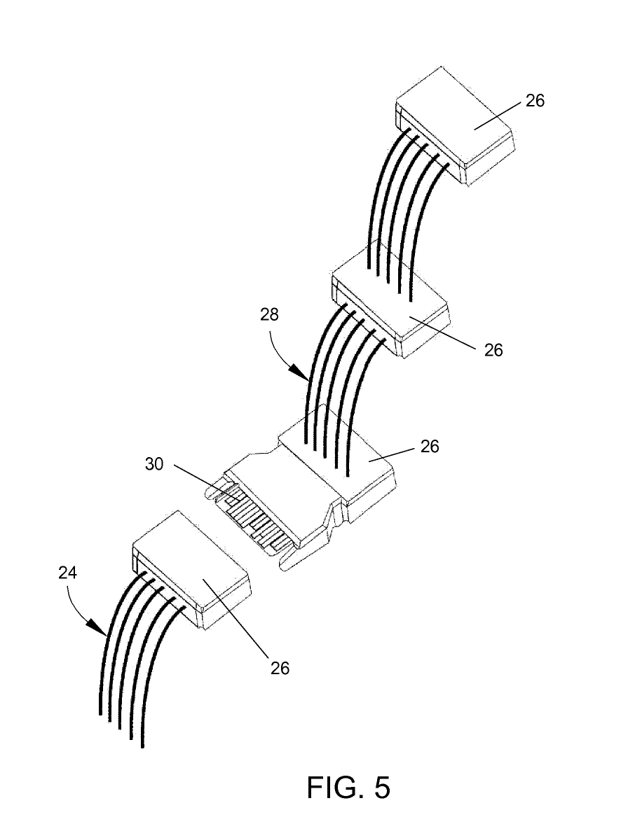

An extension cable 28 is represented in FIG. 5 as being adapted to be plugged into either of the female connectors 26 of the cable stubs 24 from the power supply unit 46 with the male connector 30 of the T-connector 34 and configured to supply power to peripheral devices through the female connector 26 of the T-connector 34 and/or any of the additional female connectors 26 on the extension cable 28 in accordance with one aspect of the invention. One or several of the female connectors 26 can be present on the same extension cable 28 characterized further by continuous wires for the different voltages and ground.

Because of the resistance and the voltage drop associated with socketed or plug contacts compared to soldered connections, it is advantageous to minimize the number of socketed connectors, for example, male connectors 30, across the length of the extension cable 28, especially when HDDs drawing considerable current are powered. Therefore, the power supply system 40 may be limited to a single plug or socketed connection between the power supply unit 46 and a peripheral device. Accordingly, and as represented in FIG. 3, two or more extension cables 28 are preferably provided, each with multiple female connectors 26, for example two, three or four female connectors 26, thereby allowing the user to pick the most suitable extension cable 28 for the configuration at hand with only one removable connection in the path, over which a voltage drop occurs. In this case, the wires of the extension cable 28 carrying power and ground are continuous and without interruption between the male connector 30 and the terminal female connector 26.

The voltage drop across a resistor is a function of the resistance and the current. Consequently, higher current passing through the resistor corresponds to a higher voltage drop. In the case of multiple daisy-chained cables connected to HDDs drawing 10-15 W or more, the supply voltage could potentially drop to a level at which function and reliability of the computer system are impacted. However, optical drives and especially SSDs typically use less power and consequently the impact of socketed connections becomes less pronounced. Moreover, if several parallel contacts are used, the resistance is lowered according to:

1/Rₜ=1/R₁+1/R₂+1/Rₙ

where Rₜ is the total resistance across the entire parallel path and n is the number of parallel resistive elements. In the case of 15-pin SATA power connectors, each voltage rail uses at least two contacts with no more estimated resistance of 50 mOhm per connector. Accordingly, the total resistance is 25 mOhm. At 5V supply power for an SSD and approximately 2.5 W peak power consumption, the voltage drop across this connector will be 12.5 mV. As a result, the target device will see 4.987V instead of 5V, which is within the tolerance range of +−5% of ATX specifications.

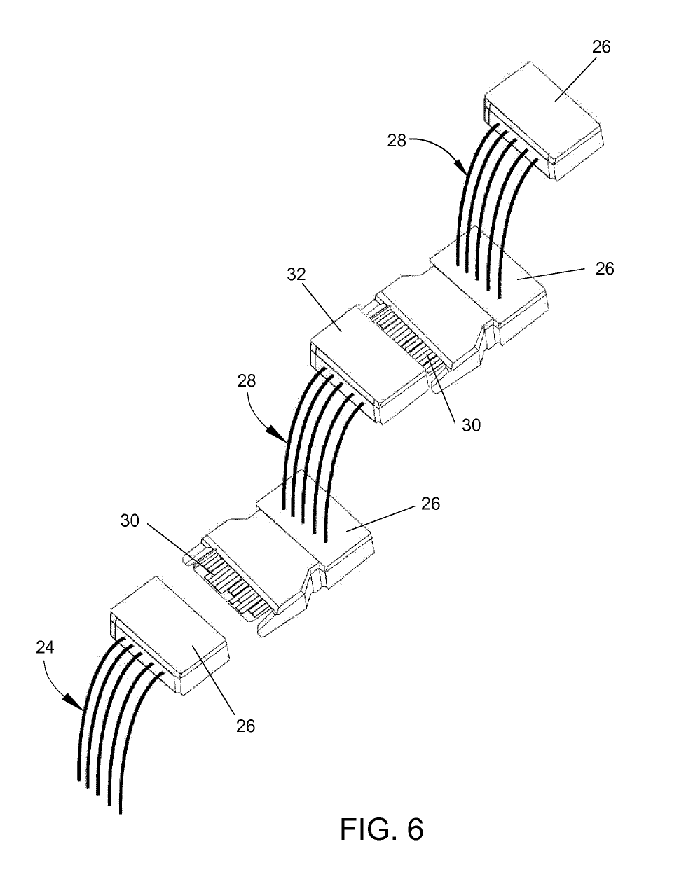

In view of the above, and especially when dealing with low power devices, it is therefore well within the electrical specification of power supply unit technology to use daisy-chains of connectors as long as the number is not excessive and causes serial resistance to add up cumulative voltage drops beyond the limits of tolerance. Therefore, the extension cables 28 may be connected in a daisy-chained manner, each extension cable 28 adapted to have the male connector 30 and at least two female connectors 26. One of the female connectors 26 used to mate with a first peripheral device and the other female connector 26 used to either mate with a second peripheral device or to accept further extension cables 28. For example, FIG. 6 schematically represents the cable stub 24 carrying power from the power supply unit 46 to two single-ended cable extensions 28 that are daisy-chained in a configuration capable of supplying power to up to three peripheral devices.

In addition to streamlining the power harness in its entirety, daisy-chaining the extension cables 28 also has the advantage of being extremely user-friendly. This may be especially true in comparison with conventional modular cables, the addition of which into an existing installation often times requires removal of drives, dismantling of entire drive bays, or even removal of the entire power supply unit for the sole purpose of gaining access to the modular connector.

The power supply system 40 of one of the embodiments described above may be installed into a computer system by connecting the main power cable 42 to the motherboard of the computer system and the multiple cable stubs 24 to peripheral devices within the computer system. As stated previously, the female connectors 26 of the cable stubs 24 may be directly connected to any of the peripheral devices or connected to one of the extension cables 28 which then is connected to one or more peripheral devices. If the extension cables 28 do not have enough female connectors 26 to connect the cable stubs 24 to all of the peripheral devices, multiple extension cables 28 may be connected in a daisy-chain manner to provide an adequate amount of female connectors 26.

While the invention has been described in terms of specific embodiments, it is apparent that other forms could be adopted by one skilled in the art. For example, other types of power connectors may emerge with future technologies. Moreover, customization of a computer system may go beyond the addition of storage media and include other peripheral devices that need to receive dedicated power. Therefore, the scope of the invention is to be limited only by the following claims.

1. A power supply system for a computer system, the power supply system comprising:
A power supply unit;
a main power cable electrically connected to the power supply unit and adapted to provide power to a motherboard of the computer system;
multiple cable stubs electrically attached to the power supply unit to provide power to peripheral devices within the computer system, at least first and second cable stubs of the cable stubs having different lengths and each of the cable stubs having a device-specific female connector configured to mate with a specific class of the peripheral devices; and,
at least one extension cable adapted to connect to the device-specific female connector of at least one of the cable stubs to allow extension of the cable stub or to power more than one of the peripheral devices.

2. The power supply system of claim 1, wherein the extension cable comprises at least two device-specific female connectors and a male connector adapted to connect to the device-specific female connector of one of the cable stubs.

3. The power supply system of claim 1, wherein the extension cable has a T-connector comprising a male connector attached to a female connector, wherein the male connector is adapted to connect with the device-specific female connector of one of the cable stubs and the female connector is adapted to connect to a specific class of the peripheral devices.

4. The power supply system of claim 3, wherein the extension cable further has at least one additional device-specific female connector.

5. The power supply system of claim 3, wherein the extension cable further has a plurality of female connectors located at incremental distances from the T-connector along the extension cable.

6. The power supply system of claim 1, wherein the extension cable is adapted to connect to at least one additional extension cable in a daisy-chain manner.

7. The power supply system of claim 1, wherein the device-specific female connectors on the cable stubs are 15-pin SATA power connectors.

8. The power supply system of claim 1, wherein the device-specific female connectors on the cable stubs are touch proof.

9. A method of powering a computer system, the method comprising:
installing a power supply system in a computer system, wherein the power supply system has a power supply unit, one main power cable to power a motherboard of the computer system, and multiple cable stubs to power peripheral devices within the computer system, wherein the main power cable and multiple cable stubs are electrically connected to the power supply unit, wherein at least a first and second cable stub of the cable stubs have different length, the cable stubs each having a device-specific female connector configured to mate with a specific class of the peripheral devices; and,
connecting at least one extension cable to the device-specific female connector of one of the cable stubs, wherein the extension cable is adapted to extend the cable stub or to power more than one of the peripheral devices; and then,
connecting the cable stubs and/or the extension cable to the peripheral devices.

10. The method of claim 9, wherein the connectors on the cable stubs are 15-pin SATA power connectors.

11. The method of claim 9, further comprising connecting multiple extension cables in a daisy-chain manner to provide power to a plurality of peripheral devices.

12. The method of claim 9, further comprising connecting at least one female connector on the extension cable to one of the peripheral devices.
